(19) United States
(12) Patent Application Publication
(10) Pub. No.: US 2012/0050148 A1
(43) Pub. Date: Mar. 1, 2012

(54) Three-Dimensional Display Using Angular Projection Backlight

(76) Inventors: Jiandong Huang, Vancouver, WA (US); Apostolos T. Voutsas, Portland, OR (US)

(21) Appl. No.: 12/873,188

(22) Filed: Aug. 31, 2010

(51) Int. Cl. G09G 3/36

(52) U.S. Cl. 345/102

(57) ABSTRACT

A three-dimensional (3D) display method is presented using an angular projection backlight panel. Bi-directional edge-coupled waveguides are formed in a plurality of rows, and a sequence of selectively enabled light extraction cells overlies each waveguide row. A first light emitting diode (LED) is enabled in a first column of LEDs interfaced to a first edge of the waveguides. The first LED supplies light to the corresponding first waveguide row. Light is projected from an enabled light extraction cell at a first angle in response to an angle tuning voltage and the angle at which light is received from the underlying waveguide row. Subsequently, light is supplied from a second LED interfaced to a second edge of the first waveguide row. Light is projected from the enabled light extraction cell at a second angle in response to the angle tuning voltage and the angle of received light.

### BACKGROUND OF THE INVENTION

1. Field of the Invention

This invention generally relates to electronic displays and, more particularly, to a three-dimensional (3D) display using an angular projection backlight.

2. Description of the Related Art

With the success of 3D movies, it is expected that 3D television will finally go mainstream. Currently, there are many 3D displays on the market. Most of them require specially designed glasses to create different images in audience's left and right eyes. In addition, the displays must operate in special 3D modes to be compatible with the glasses. From the viewer's perspective, it is desirable to see 3D images without the need of special glasses. In addition, for many handheld portable devices, it is hard to justify the extra cost for the viewing glasses.

As the thickness of flat-panel liquid crystal (LC) displays is reduced to below 1 centimeter (cm), conventional backlight designs such as compact fluorescent lamp (CFL), which require that the light sources be distributed across the backlight panels, cannot be used due to the geometry limitations of these light sources. Ultra-thin display designs might be implemented using LEDs with small-volume packages. But the cost of these implementations can be high since a large number of LEDs would be required.

Display designs with edge-coupled LEDs using large-size multiple-mode waveguide light pipes enable ultra-thin LC display designs while reducing the number of LEDs used in those displays as well. The edge-coupled schemes reduce the cost of backlight dramatically in addition to supporting the stylish thin look of the displays.

However, the image quality of these edge-coupled displays cannot match that of displays using distributed LEDs as backlight light sources in the backlight panels. For the latter case, each LED light extraction cell of the backlight systems can be individually addressed to create low resolution images of desired images. With the synchronization of backlight low resolution images, in time and spatial domain, to the images on the front high-resolution LC panels, high quality images can be realized with higher contrasts and dynamic responses. In this kind of display implementation, the capability to address desired backlight light extraction cells is the key enabling technology, which is not easily achievable using edge-coupled LED backlight systems.

It would be advantageous if a display using edge-coupled LEDs could be adapted for use in 3D applications.

### SUMMARY OF THE INVENTION

Disclosed herein is a three-dimensional (3D) display that eliminates the need for special glasses. The display is fully compatible with conventional two-dimensional (2D) applications, adding to its affordability. Due to the angular distribution of scattered light from the display backlight waveguide pipes, scattered light is projected in a strong angular distribution away from the normal direction. Images created on the display front panels are projected to the left and right eyes sequentially. By using the angular distribution for decomposition into images for left and right eyes, this display can be used to project the corresponding images to desired left or right eyes, creating the perceived image differences that form 3D images. No viewing glasses are required for this type of 3D display.

Accordingly, a 3D display method is presented using an angular projection backlight panel. A front panel is provided with an array of selectively enabled color pixels. Underlying the front panel is a backlight panel with bi-directional edge-coupled waveguides formed in a plurality of rows, where each waveguide row underlies a sequence of selectively enabled light extraction cells. A first waveguide row is selected and a first light emitting diode (LED) is enabled in a first column of LEDs interfaced to a first edge of the backlight waveguides, where the first LED supplies light to the corresponding first waveguide row. A light extraction cell is selected to enable overlying the first waveguide row. An angle tuning voltage is selected and supplied to the enabled light extraction cell, and light is projected from the enabled light extraction cell at a first angle with respect to a backlight panel surface in response to the angle tuning voltage and the angle at which light is received from the underlying waveguide row. Subsequent to disabling the first LED, light is supplied from a second LED in a second column of LEDs interfaced to a second edge of the backlight waveguides, where the second LED supplies light to the first waveguide row. Light is projected from the enabled light extraction cell at a second angle with respect to the backlight panel surface in response to the angle tuning voltage and the angle at which light is supplied by the underlying waveguide row.

In one aspect, light from the first LED is supplied in a first sub-frame of a time division multiplexed (TDM) sequence, and light is supplied from the second LED in a second sub-frame of the TDM sequence. By iteratively selecting waveguide rows, a light extraction cell to enable in each selected row, accepting angle tuning voltages for enabled light extraction cells, and alternately illuminating each enabled light extraction cell in the first and second sub-frames, a 3D representation is projected of front panel color pixels respectively overlying enabled light extraction cells.

In another aspect, projecting light at the first and second angles includes projecting light at an obtuse angle formed between the direction at which the light enters a waveguide row and the direction from which the light is projected from that backlight panel surface.

Additional details of the above-described method and a 3D display using an angular projection backlight panel are presented below.

### BRIEF DESCRIPTION OF THE DRAWINGS

FIGS. 1A and 1B are, respectively, plan and partial cross-sectional views of a three-dimensional (3D) display with an angular projection backlight panel.

FIGS. 2A and 2B are partial cross-sectional views of the display of FIG. 1B emphasizing geometric relationships.

FIG. 3 is a partial cross-sectional view of another variation of the display of FIGS. 1A and 1B.

FIG. 4 is a diagram depicting the angular distribution of scattered light from waveguide pipes with a scattering mean free path of Lₘₑₐₙ=0.0097 millimeters (mm) and a light extraction cell thickness of T_{cell}=0.01 mm.

FIG. 5 is a diagram illustrating the basic principles of using an angular projection backlight to create a 3D image.

FIG. 6 is a diagram depicting the timing sequences needed to support 3D operation.

FIGS. 7A and 7B are, respectively, partial cross-sectional and plan views illustrating the concept of addressing individual backlight (areas) light extraction cells for the edge-coupled LED backlight system.

FIG. 8 is a cross-sectional view of a light extraction cell enabled as a polymer network liquid crystal (PNLC) cells placed on top of waveguide pipes.

FIGS. 9A and 9B are, respectively, cross-sectional and plan views illustrating strong angular dependent light extraction from a waveguide.

FIG. 10 is a diagram defining the far field angular distribution of observed light.

FIG. 11 is a diagram depicting a model of Mie scattering angular distribution.

FIG. 12 is a diagram depicting the angular distribution of extracted light from waveguide pipes with a scattering mean free path Lₘₑₐₙ=0.0097 mm and a cell thickness T_{cell}=0.01 mm.

FIG. 13 is a diagram explaining the light extraction by Mie scattering model for angular dependent distributions.

FIG. 14 is a diagram depicting the angular distribution of extracted light from waveguide pipes with a scattering mean free path Lₘₑₐₙ=0.0097 mm, much less than the cell thickness T_{cell}=0.1 mm.

FIG. 15 is a diagram depicting the angular distribution of extracted light from waveguide pipes with a scattering mean free path Lₘₑₐₙ=0.00097 mm, which is much less that the cell thickness T_{cell}=0.01 mm.

FIG. 16 is diagram depicting improvements in the emission angular profiles by using small ratio of Lₘₑₐₙ/T_{cell} devices with bi-directional. LED input coupling.

FIG. 17 is a flowchart illustrating a 3D display method using an angular projection backlight panel.

### DETAILED DESCRIPTION

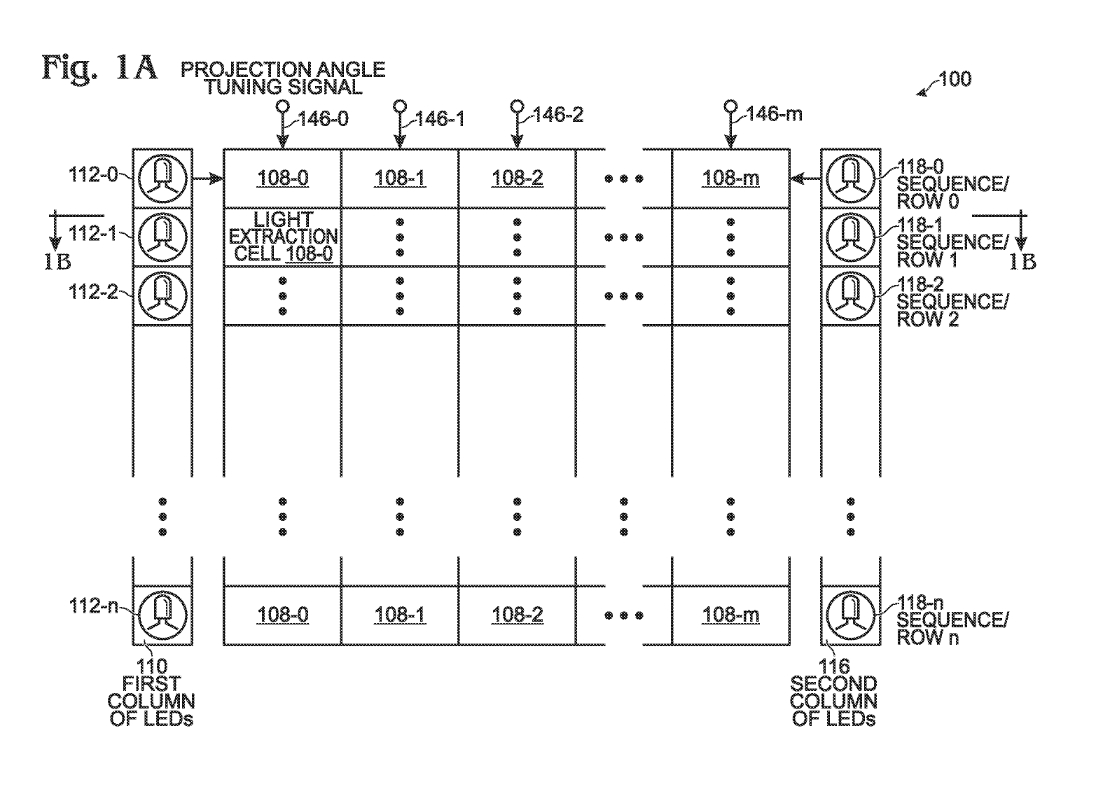

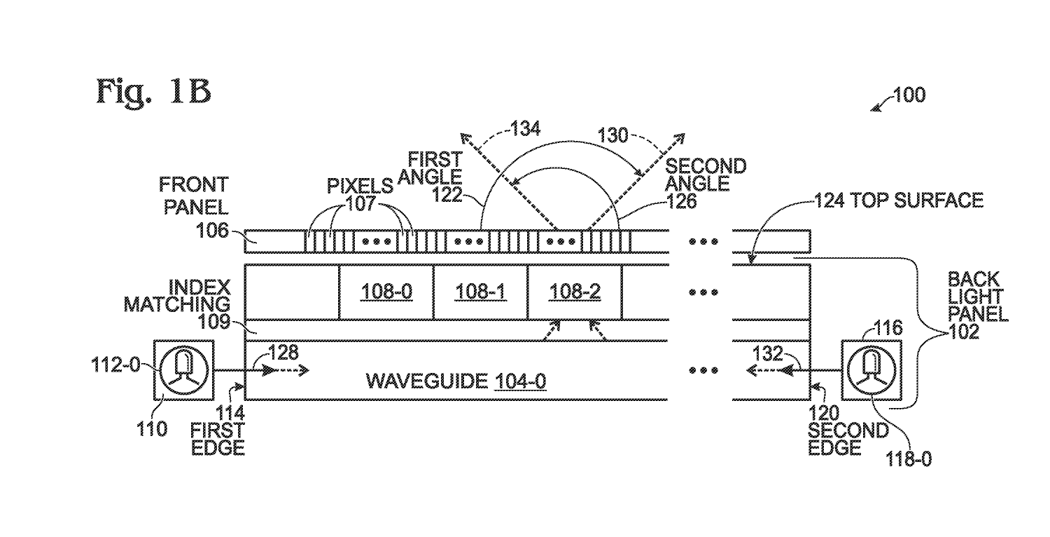

FIGS. 1A and 1B are, respectively, plan and partial cross-sectional views of a three-dimensional (3D) display with an angular projection backlight panel. The display 100 comprises a backlight panel 102 formed from a plurality of bi-directional edge-coupled waveguides 104 arranged in rows. Shown are waveguides 104-0 through 104-n, where n is an integer variable not limited to any particular value. The waveguides are respectively associated with rows 0 through n.

The display includes a front panel 106 with an array of selectively enabled pixels 107. The pixels are conventionally color pixels. Color pixel arrays are well known in the art and the display 100 may be enabled with any type of front panel requiring a backlight panel. In one aspect, each pixel may be comprised of subpixels. For example, the subpixels may be associated with red, green, and blue (RGB) colors.

The backlight panel 102 also includes light extraction cells 108. An index matching material 109 may be placed between the waveguide rows 104 and the light extraction cells. Each waveguide row 104 is associated with a corresponding sequence of selectively enabled light extraction cells 108. Shown are sequences 0 through n. Note: in FIG. 1A the front panel is removed to show the sequences of light extraction cells 108. As shown, the light extraction cells 108 overlie the waveguide row, but in other aspects (not shown) and well known in the art, the light extraction cells may underlie the waveguide. In this aspect, light is projected through the light extraction cells to a reflective surface underlying the light extraction cells, and reflected to a front panel overlying the waveguide. As shown, a plurality of pixels 107 overlies each single light extraction cell 108.

Shown in FIG. 1B are light extraction cells 108-0 through 108-m in sequence 0, where m is an integer variable not limited to any particular value. Typically, each sequence would typically include the same number (m) of light extraction cells. In one aspect, the light extraction cells 108 are formed from liquid crystal (LC) cells interposed between transparent electrodes, as explained in more detail below.

A first column 110 of light emitting diodes (LEDs) 112 is interfaced to a first edge 114 of the waveguides 104, where each LED supplies light to a corresponding waveguide row. Thus, LED 112-0 supplies light to row 0 and LED 112-n supplies light to row n. Note: for simplicity a single LED is shown associated with the first edge of each waveguide 104. However, it should be understood that one than one LED may be assigned to a row at each waveguide edge.

Likewise, a second column 116 of LEDs 118 is interfaced to a second edge 120 of the waveguides 104, where each LED 118 supplies light to a corresponding waveguide row. Thus, LED 118-0 supplies light to row 0 and LED 118-n supplies light to row n. Note: for simplicity a single LED is shown associated with the second edge 120 of each waveguide 104. However, it should be understood that more than one LED may be assigned to a row at each waveguide edge. LEDs 118 in the second column 116 are alternately engagable with the first column of LEDs 110.

Light is projected through a first enabled light extraction cell (e.g., 108-2) overlying a first waveguide row (e.g., 104-0) at a first angle 122 with respect to a front panel top surface 124, in response to enabling a first LED (e.g., 112-0) in the first column 110 of LEDs. That is, the first LED is associated with the first waveguide row. Likewise, light is projected through the first enabled light extraction cell at a second angle 126 with respect to the front panel top surface 124, in response to enabling a second LED (e.g., 118-0) in the second column 116 of LEDs, where the second LED is associated with the first waveguide row.

As shown in FIG. 1A, each light extraction cell 108 may include a (projection) angle tuning port on line 146-0 through 146-m. For example, light extraction cell 108-2 in each sequence may be connected in parallel on line 146-2. However, since the light extraction cells can be enabled on a sequence-by-sequence basis, the signal on the projection angle tuning ports can be adjusted uniquely for each sequence. Typically however, the projection angle tuning port remains constant following an initial adjustment. In another aspect not shown, each light extraction cell is assigned a unique signal line.

Therefore, the first enabled light extraction cell (e.g., 108-2) projects light at a first angle 122 in response to enabling the first LED (112-0), accepting an angle tuning voltage (on line 146-2), and the angle at which light is received from the underlying waveguide row. To support 3D operation, the first angle may be obtuse. The obtuse angle 122 (FIG. 1B) is formed between the direction 128 at which the light enters the waveguide row (pipe) and the direction 130 from which the light is projected from the backlight panel 124. Likewise, the first enabled light extraction cell projects light at a second angle 126 in response to enabling the second LED (e.g., 118-0), supplying the angle tuning voltage, and the angle at which light is received from the underlying waveguide row. Again the angle may be obtuse. Obtuse angle 126 is formed between the direction 132 at which the light enters the waveguide pipe and the direction 134 from which the light is projected from the backlight panel surface. As shown in FIG. 8, the light extraction cells may receive light at an obtuse angle (as defined above) from the underlying waveguide. Typically, this angle remains constant in use, although the angle can be modified through the choice of waveguide material, dimensions, and the angle at which light is input into the waveguide pipe. The first and second obtuse angles may also be described as “opposite” in that they are located on opposite sides on an angle that is orthogonal with respect to the backlight panel surface.

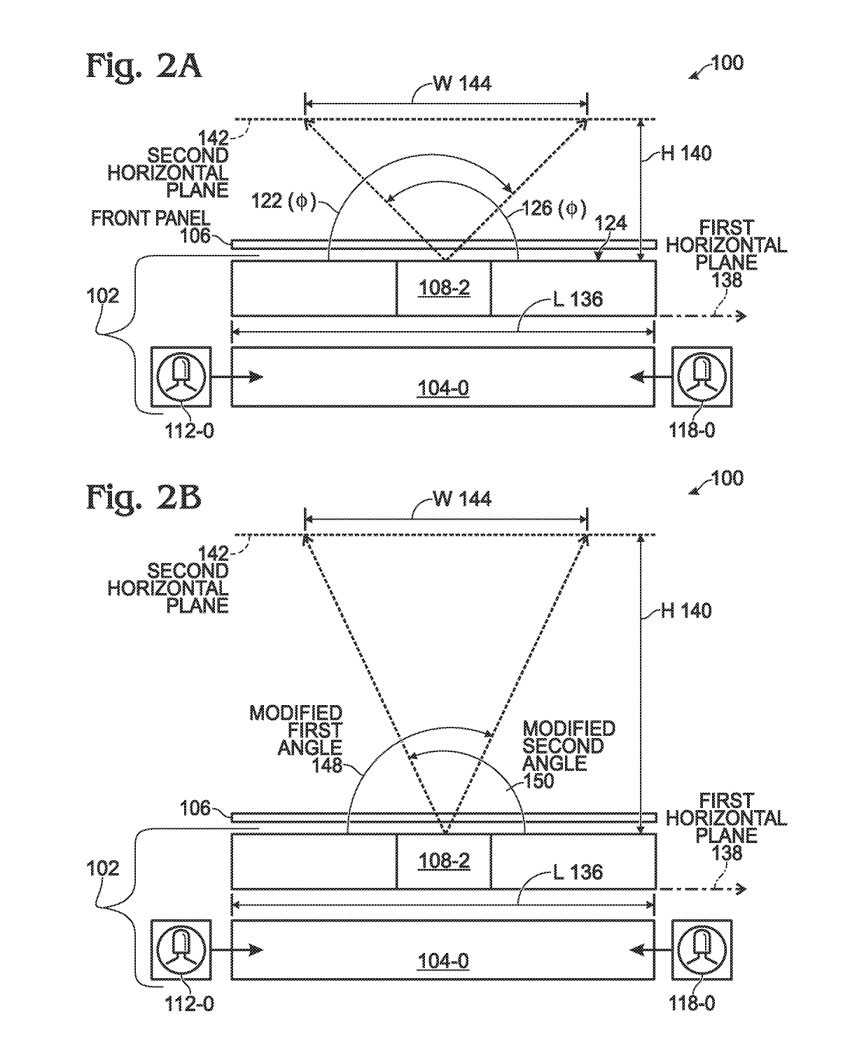

FIGS. 2A and 2B are partial cross-sectional views of the display of FIG. 1B emphasizing geometric relationships. The backlight panel has a top surface 124 with a length (L) 136 in a first horizontal plane 138. The enabled light extraction cell projects light at the first angle (φ) 122=second angle (φ) 126, as follows:

tan(180−φ)=2H/(W+L);

where H 140 is a distance along a vertical plane between the backlight panel top surface 124 and a second horizontal plane 142 overlying the first horizontal plane 138. The vertical plane bisects L 136, and W 144 is a distance along the second horizontal plane bisected by the vertical plane 142. For example, H 140 represents the distance between a viewer and the display, and W may represent the distance between a viewer's left and right eyes.

As seen by contrasting FIGS. 2A and 2B, the first enabled light extraction cell is able to project light at a modified first angle 148 and modified second angle 150 in response to changing the projection angle tuning voltage, where the value of H 140 changes while the value of W 144 remains constant. As explained in more detail below, the application of projection angle tuning voltages change the scattering mean free path. In one aspect the angle tuning voltage modifies the conformity (dipole alignment) of a polymer network LC (PNLC) cell, resulting in a change in the index of refraction, which in turn, results in a change in the scattering mean free path. The ratio of the LC cell thickness over the mean free path is a parameter that determines the angular scattering profile. By tuning the mean free path with the angle tuning voltage, while keeping the thickness of LC cells fixed, the projection angles can be tuned.

The response of polymer network liquid crystal molecules to an electric field is the major characteristic utilized in industrial applications. The ability of the director to align along an external field is caused by the electric nature of the molecules. Permanent electric dipoles result when one end of a molecule has a net positive charge while the other end has a net negative charge. When an external electric field is applied to the liquid crystal, the dipole molecules tend to orient themselves along the direction of the field. Even if a molecule does not form a permanent dipole, it can still be influenced by an electric field. In some cases, the field produces a slight re-arrangement of electrons and protons in molecules such that an induced electric dipole results. While not as strong as permanent dipoles, an orientation with the external field still occurs.

Because of the birefringence of liquid crystal materials, the effective refractive index may be a squared average of the indexes along two directions. Therefore, depending on the LC molecule alignment, different effective indexes can be achieved. If all the LC molecules are aligned in parallel to an incident light ray, the effective index reaches its minimum value nₒ, i.e., the ordinary refractive index value. If the LC molecules are aligned perpendicular, the effective index reaches the maximum value square root of ((nₒ²+nₒ²)/2). This refractive index change is the largest value that can be achieved with a nematic liquid crystal.

In summary, the angle tuning voltage is able to modify the angle at which light is projected through an LC cell by changing the local orientation of the LC dipoles in polymer networks. Changes in the local orientation of LC molecules affect a change in the spatial distribution of the refractive index, which affects the projection angle.

In one aspect, the first LED (112-0) is enabled to supply light in a first sub-frame of a time division multiplexed (TDM) sequence, and the second LED (118-0) is enabled to supply light in a second sub-frame of the TDM sequence. Enabled light extraction cells may project light at opposite non-orthogonal first and second angles in response to the angle tuning voltage. The angles are “opposite” in that they are located on opposite sides of an angle that is orthogonal to the backlight panel surface, as shown in FIGS. 1B and 2A. Expanding on this principle, a 3D image is projected in response iteratively selecting waveguide rows 104, enabling a light extraction cell 108 in each sequence, accepting angle tuning voltages for enabled light extraction cells, enabling a front panel color pixel overlying each enabled light extraction cell, and illuminating each enabled light extraction cell in the first and second sub-frames. Thus, light extraction cells are turned on in sequence, with the LED output intensity tuned from 0 to full power, to produce the overall image intensities associated with the enabled light extraction cells, which is also referred to as a local dimming function, since the other parts of display are dimmed except the enabled light extraction cell.

In one variation, the first LED (112-0) and second LED (118-0) are simultaneously enabled. Then, a two-dimensional (2D) image can be projected in response to iteratively selecting waveguide rows 104, enabling a light extraction cell 108 in each selected waveguide row 104, accepting angle tuning voltages for enabled light extraction cells, enabling a front panel color pixel overlying each enabled light extraction cell, and simultaneously illuminating each enabled light extraction cell 108 from the first edge 114 and second edge 120 of each selected waveguide row 104.

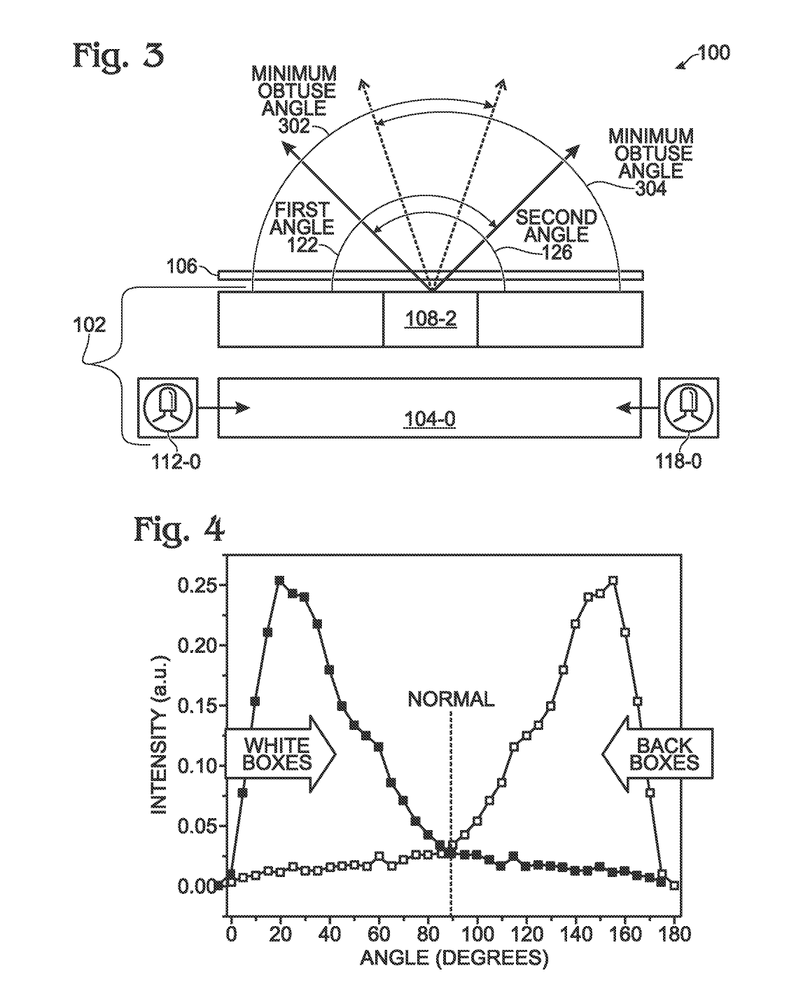

FIG. 3 is a partial cross-sectional view of another variation of the display 100 of FIGS. 1A and 1B. In this variation, each light extraction cell 108 includes a (projection) angle tuning port (shown in FIG. 1A as lines 146-0 through 146-m). An enabled light extraction cell is able to project light at a minimum obtuse angle 302 and 304 with respect to a top surface of the front panel 124 in response to accepting a minimum (projection) angle tuning voltage on line 200. If the first LED (e.g., 112-0) is enabled to supply light in a first sub-frame of a TDM sequence, and the second LED (e.g., 118-0) is enabled to supply light in a second sub-frame of the TDM sequence, then a 2D image can be projected in response iteratively selecting waveguide rows 104, enabling a light extraction cell 108 in each selected waveguide row 104, accepting the minimum tuning voltage for each enabled light extraction cell 108, enabling a front panel color pixel overlying each enabled light extraction cell, and illuminating each enabled light extraction cell in the first and second sub-frames.

### Functional Description

FIG. 4 is a diagram depicting the angular distribution of scattered light from waveguide pipes with a scattering mean free path of Lₘₑₐₙ=0.0097 millimeters (mm) and a light extraction cell thickness of T_{cell}=0.01 mm. Clearly, it is seen that the scattered light exhibits a strong angular distribution away from the normal (orthogonal) direction. Light entering the waveguide from the “left” side is associated with the white box data points. Light entering the “right” side of the waveguide is associated with the black box data points.

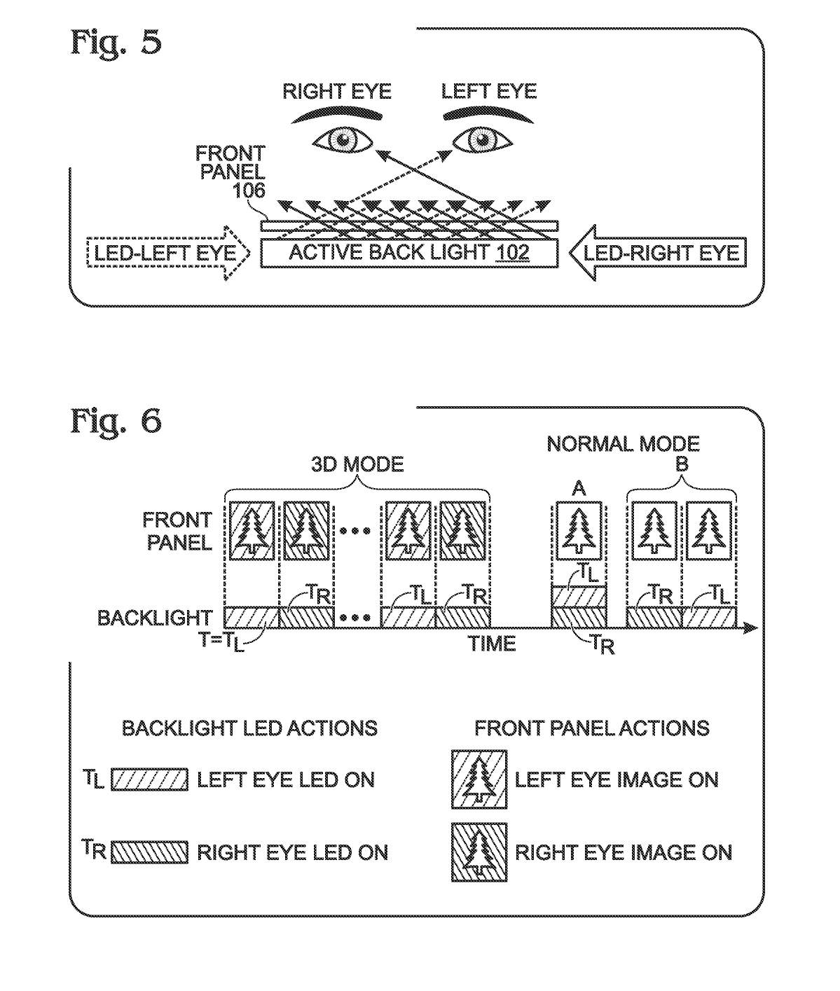

FIG. 5 is a diagram illustrating the basic principles of using an angular projection backlight to create a 3D image. Images generated at the front panels are sequentially projected to left and right eyes. By decomposing images for left and right eyes, a display can be used to project the corresponding images to desired left or right eyes, creating the perceived image differences needed to form 3D images. No viewing glasses are required for this type of 3D display. No brightness-enhanced films are required to randomize the light distributions.

FIG. 6 is a diagram depicting the timing sequences needed to support 3D operation. In the 3D mode, the left or right eye images are projected to audiences' left, and right eyes by turning on left-eye or right-eye LEDs in the desired left-eye or right-eye time slots. The operational principles are compatible with current 3D formats. For normal non-3D contents (normal mode A), the display does not require any extra adjustments other than simultaneously filling both left-eye and right-eye time slots. Alternately, in normal mode B the projection angles can be minimized and the left-eye and right-eye time slots are sequenced, as explained in the description of FIG. 3. In another aspect, normal mode A can be enabled using minimally obtuse projection angles.

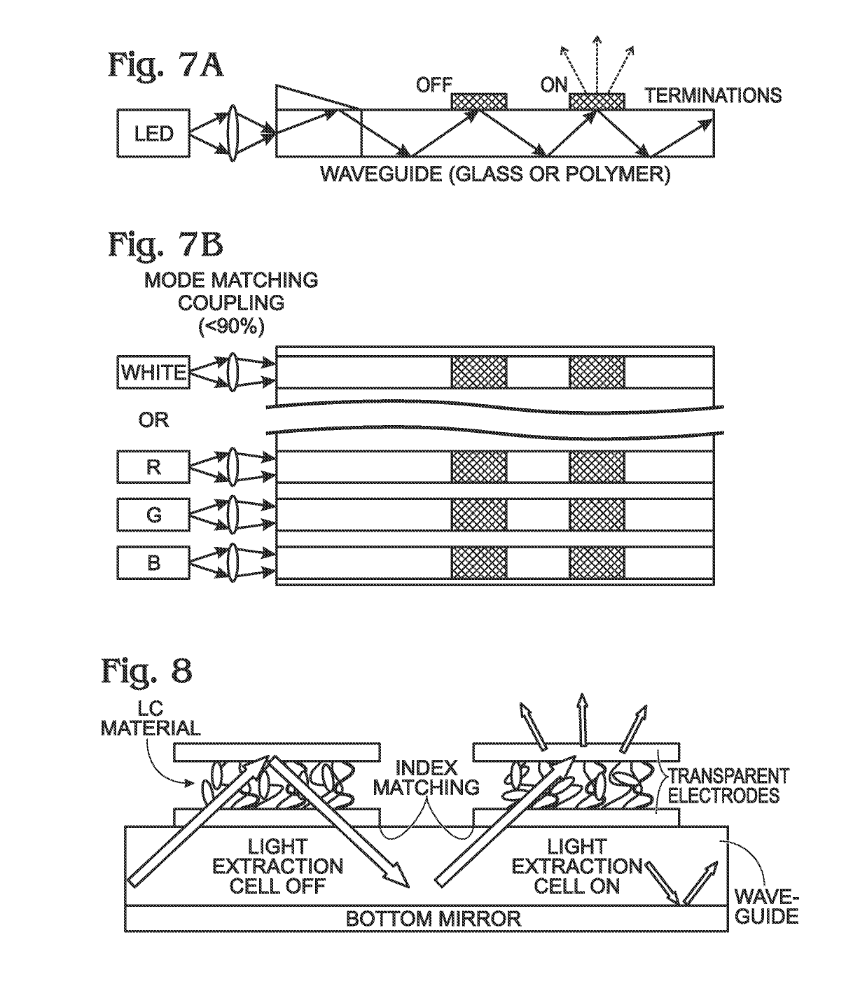

FIGS. 7A and 7B are, respectively, partial cross-sectional and plan views illustrating the concept of addressing individual backlight (areas) light extraction cells for the edge-coupled LED backlight system. Local dimming functions are associated with a controlled surface roughness. That is, roughing can be used to disable the total internal reflections required for light waveguiding, so that light is emitted from the waveguide in selected desired sites. The backlight can be enabled using white of red/blue/green (RGB) LEDs.

FIG. 8 is a cross-sectional view of a light extraction cell enabled as a polymer network liquid crystal (PNLC) cells placed on top of waveguide pipes. The principles behind using LC materials to gate light are well understood in the art. The LC cell can be made using transparent electrodes, with the bottom electrodes matched to the refractive index of the waveguide material.

Numerical models have been developed that show that the scattered light from waveguide light pipes is strongly angular dependent due to a scattering mechanism based on the relative ratio between the dimension scale of the scatters and light wavelengths. Most of the scattering events can be regarded as Mie scattering. Mie theory, also called Lorenz-Mie theory or Lorenz-Mie-Debye theory, is an analytical solution of Maxwell's equations for the scattering of electromagnetic radiation by spherical particles (also called Mie scattering). This approach is used to explain the behavior of light in interactions with particles having a size similar to that of the wavelength of light.

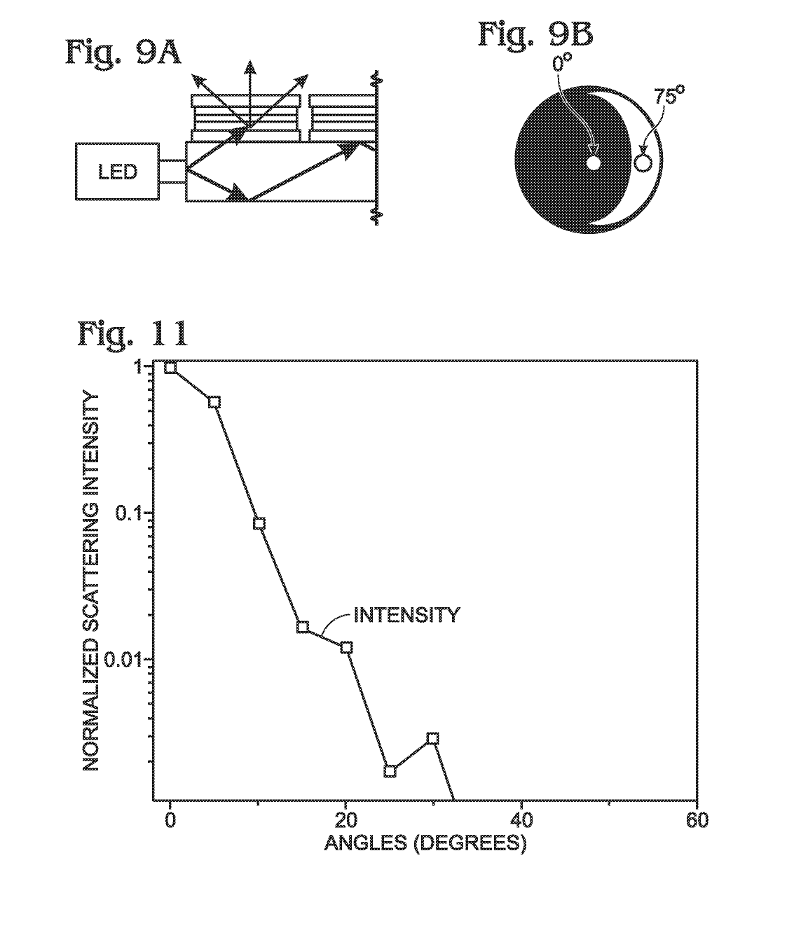

FIGS. 9A and 9B are, respectively, cross-sectional and plan views illustrating strong angular dependent light extraction from a waveguide.

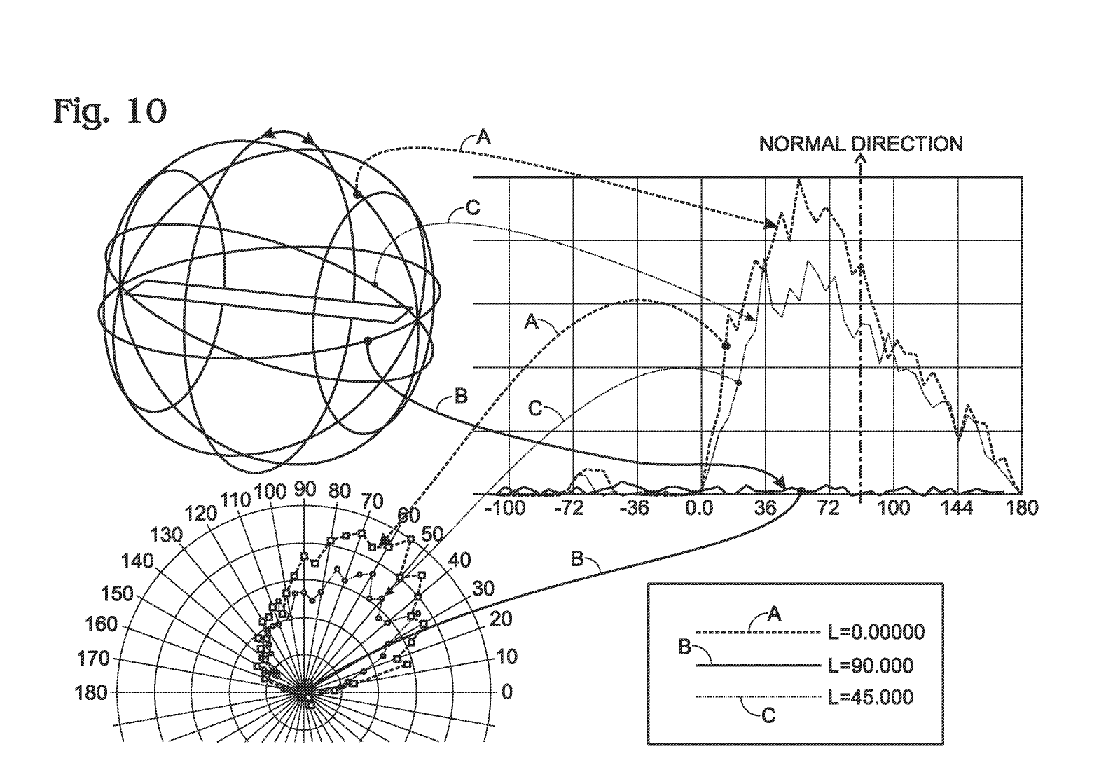

FIG. 10 is a diagram defining the far field angular distribution of observed light. The “A” curves represent the slice data that cut through the input LED and center of the waveguide with 0-degrees pointing to the Z-axis direction and 90-degrees pointing to normal direction of the waveguide. For backlight applications, the normal direction points to the front LC panels. Thus, it is desirable to steer light into this direction, even without brightness enhancement films.

Since Mie scattering is the dominate scattering mechanism inside the addressable scattering LC cells, it is convenient to define a scattering mean free path, Lₘₑₐₙ, which is inversely proportional to the product of average scattering cross-section of scatters, σ_{Sc}, and scatter density, N, where N is defined as the average particle numbers inside a unit volume.

Lₘₑₐₙ˜1/(σ_{Sc}×N) Equation 1

FIG. 11 is a diagram depicting a Mie model of scattering angular distribution. The mean free path can be adjusted by changing either the scattering cross-section or the density of scatters. For convenience, adjustment of the scatter density is considered while keeping the Mie scattering cross section as constant, with the resultant scattering angular distribution as shown in the figure. For non-ideal devices, the ensemble of scatters might be composed of scatters with differences in size or shape, but the mean free path can still be defined as in Equation 1.

The relative ratio between the mean free path and the cell thickness determines the far field angular distributions of scattered light from a device. For convenience, only two values of mean free path and two values of scattering cell thickness (T_{cell}) are considered, which differ by one order of magnitude, to illustrate the device physics, see Table 1.

TABLE 1
Values of Mean Free Path and Cell Thickness

| | | |
|---|---|---|
| L_{Mean}(mm) | 0.0097_{Long} | 0.00097_{Short} |
| T_{cell}(mm) | 0.01_{Thick} | 0.001_{Thin} |

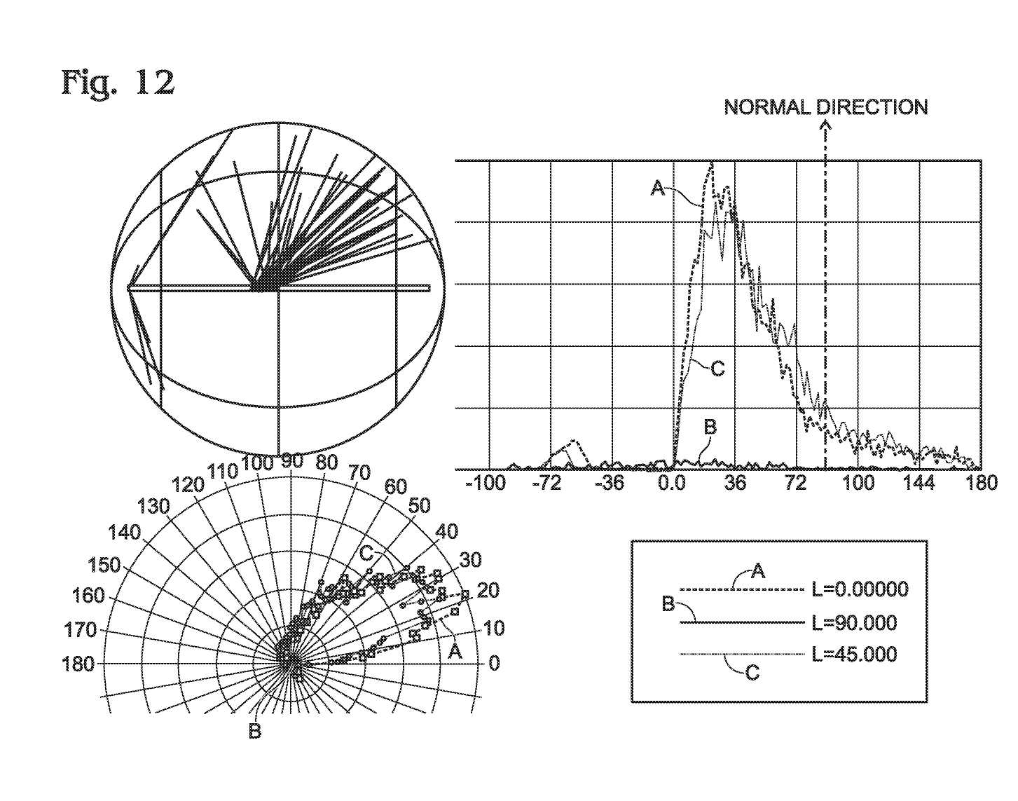

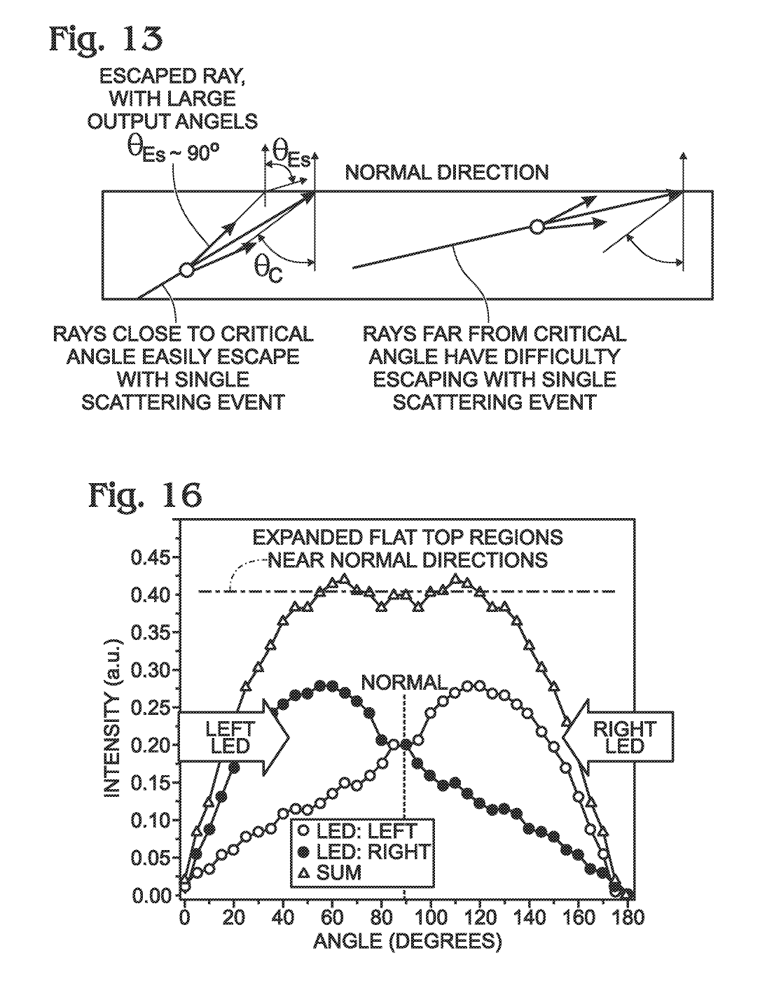

FIG. 12 is a diagram depicting the angular distribution of extracted light from waveguide pipes with a scattering mean free path Lₘₑₐₙ=0.0097 mm and a cell thickness T_{cell}=0.01 mm. It is seen that the scattered light exhibits strong angular distribution away from the normal direction.

FIG. 13 is a diagram explaining the light extraction by Mie scattering model for angular dependent distributions. The figure explains why strong angular distributions are expected from Mie theory. For light guided by the waveguide pipe, if the mean free path of the cell is compatible with the cell thickness, the light is mostly scattered in a single event. Since Mie theory predicts very small angular distributions for the single scattering event, only those rays near the critical angel 8, are easily scattered out of the waveguides. But with large (near 90 degree) escape angles, it is difficult for light to scatter out of the waveguide.

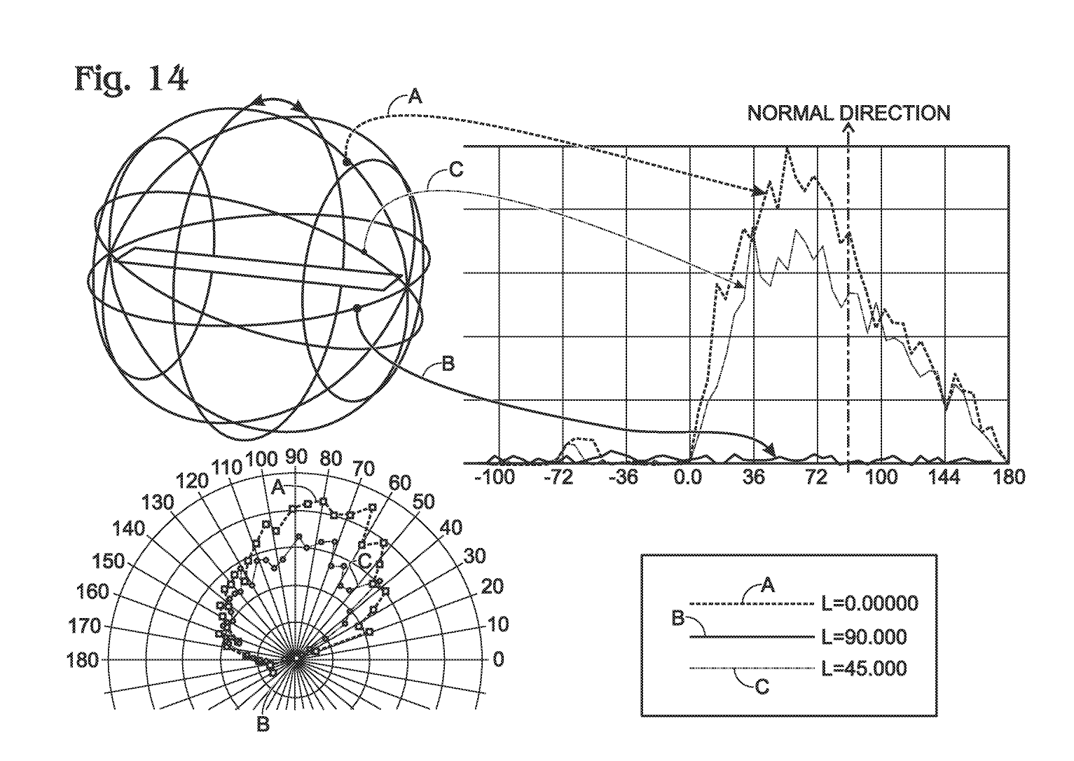

FIG. 14 is a diagram depicting the angular distribution of extracted light from waveguide pipes with a scattering mean free path Lₘₑₐₙ=0.0097 mm, much less than the cell thickness T_{cell}=0.1 mm. The scattering mean free path is the same as in FIG. 12, but the cell thickness is increased by an order of magnitude. It is seen that the peak of scattered light exhibits a shift towards the normal direction.

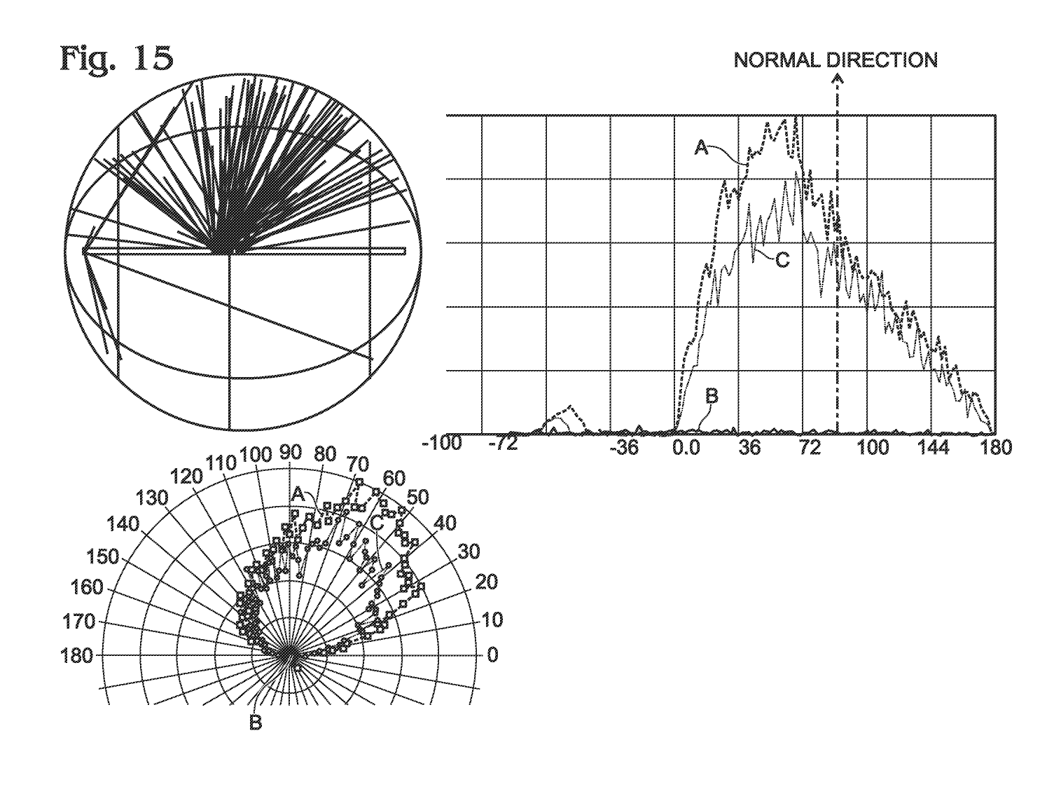

FIG. 15 is a diagram depicting the angular distribution of extracted light from waveguide pipes with a scattering mean free path Lₘₑₐₙ=0.00097 mm, which is much less that the cell thickness T_{cell}=0.01 mm. The cell thickness is the same as in FIG. 12, but the scattering mean free path is increased by one order of magnitude. It is seen that the peak of scattered light exhibits a shift towards the normal direction.

Based on the device physics, the scattering strength inside an LC cell can be optimized to create better angular distributions. There are two ways to achieve the enhanced scattering strengths: (1) lowering the mean free path; (2) increasing the cell thickness. That is, the ratio of cell thickness to scattering mean free path is optimized to improve the angular distributions, as shown in FIGS. 15 and 16.

FIG. 16 is diagram depicting improvements in the emission angular profiles by using small ratio of Lₘₑₐₙ/T_{cell} devices with bi-directional LED input coupling.

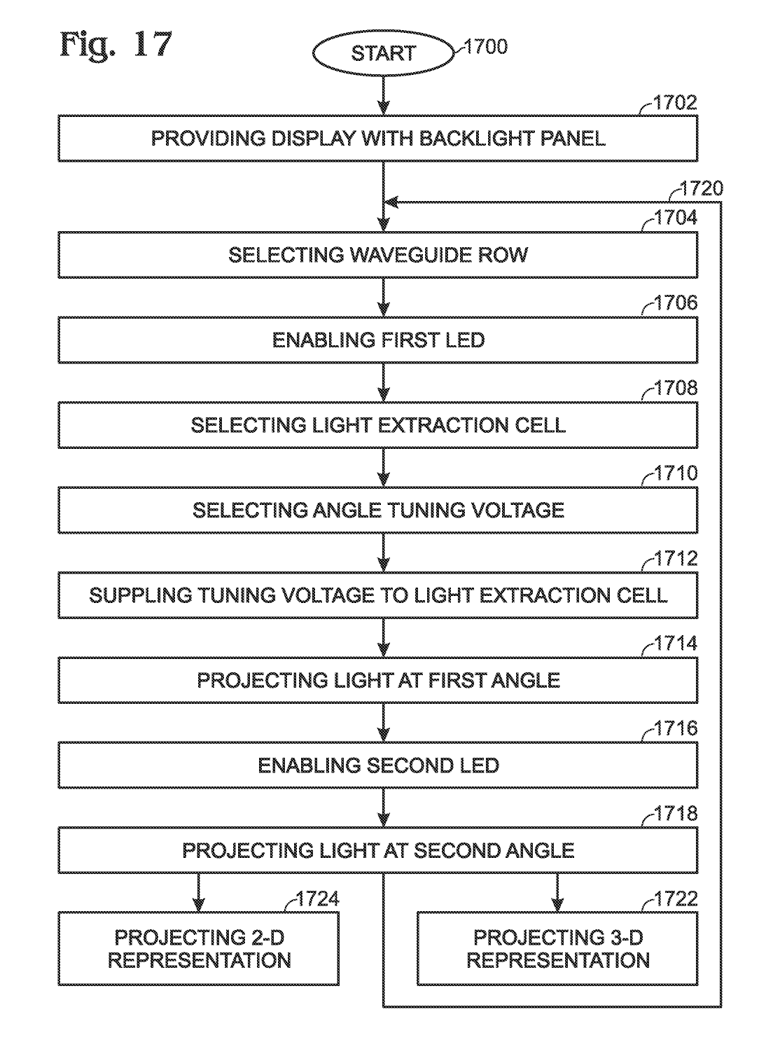

FIG. 17 is a flowchart illustrating a 3D display method using an angular projection backlight panel. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the steps are performed in numerical order. The method starts at Step 1700.

Step 1702 provides a front panel with an array of selectively enabled pixels and a backlight panel with bi-directional edge-coupled waveguides formed in a plurality of rows. Each waveguide row interfaces with a sequence of selectively enabled light extraction cells. In one aspect, the light extraction cells are formed from liquid crystal (LC) cells interposed between transparent electrodes. Step 1704 selects a first waveguide row. Step 1706 enables a first LED in a first column of LEDs interfaced to a first edge of the backlight waveguides, where the first LED supplies light to the corresponding first waveguide row. In one aspect, Step 1706 selects the light intensity supplied by each LED. Step 1708 selects a light extraction cell to enable overlying the first waveguide row.

Step 1710 selects an angle tuning voltage, and Step 1712 supplies the selected tuning voltage to the enabled light extraction cell. Step 1714 projects light from the enabled light extraction cell at a first angle with respect to a backlight panel surface in response to the angle tuning voltage and the angle at which the light is received from the underlying waveguide row. Subsequent to disabling the first LED, Step 1716 supplies light from a second LED in a second column of LEDs interfaced to a second edge of the backlight waveguides, where the second LED supplies light to the corresponding first waveguide row. Step 1718 projects light from the enabled light extraction cell at a second angle with respect to the backlight panel surface in response to the angle tuning voltage and the angle at which light is received from the underlying waveguide row.

In one aspect, supplying light from the first LED in Step 1706 includes supplying the light in a first sub-frame of a time division multiplexed (TDM) sequence. Supplying light from the second LED in Step 1716 includes supplying the light in a second sub-frame of the TDM sequence. Steps 1714 and 1718 may project light at opposite non-orthogonal first and second angles (as defined above). As represented by the flowchart path labeled 1720, the method iteratively selects waveguide rows, a light extraction cell to enable in each selected row, accepts angle tuning voltages for enabled light extraction cells, and alternately illuminates each enabled light extraction cell in the first and second sub-frames. As a result, Step 1722 projects a 3D representation of enabled front panel pixels respectively overlying enabled light extraction cells.

In one aspect, projecting light at the first angle in Step 1714 includes projecting light at an obtuse first angle formed between the direction at which the light enters the backlight and the direction from which the light is projected from the backlight panel surface. Projecting light at the second angle in Step 1718 includes projecting light at an obtuse second angle formed between the direction at which the light enters the waveguide row and the direction from which the light is projected from the backlight panel surface.

More explicitly, Step 1702 provides a backlight panel surface with a length (L) in a first horizontal plane. Then, projecting light at the first angle (φ)=second angle (φ), in Steps 1714 and 1718 is as follows:

tan(180−φ)=2H/(W+L);

where H is a distance along a vertical plane between the backlight panel surface and a second horizontal plane overlying the first horizontal plane,

where the vertical plane bisects L; and,

where W is a distance along the second horizontal plane bisected by the vertical plane. Note: the thickness of the front panel would be included in the calculation of the distance W.

In another aspect, Steps 1706 and 1716 simultaneously supply light to an enabled light extraction cell in the first waveguide row from both the first and second LEDs. As a result, Step 1714 is likewise performed simultaneously with Step 1718. As represented by the flowchart path labeled 1720, the method iteratively selects waveguide rows, a light extraction cell to enable overlying each selected row, accepts angle tuning voltages for enabled light extraction cells, and simultaneously enables LEDs from the first and second edges of each selected waveguide row. Step 1724 projects a 2D representation of enabled front panel pixels respectively overlying enabled light extraction cells.

If Step 1710 selects a minimum angle tuning voltage, Steps 1714 and 1718 project light at first and second angles that are minimally obtuse with respect to the backlight panel surface in response to the minimum angle tuning voltage. By iteratively selecting waveguide rows, a light extraction cell to enable in each selected row, accepting minimum angle tuning voltages for each enabled light extraction cell, and alternately enabling LEDs from the first and second edges of each selected waveguide row, Step 1724 projects a 2D representation of the enabled front panel pixels overlying respectively enabled light extraction cells.

In another 3D aspect of the method, Steps 1714 and 1718 determine the value of H in response to selecting the first and second angles. In one variation, the first and second angles are selected to determine a (modified) value of H while maintaining the value of W as a constant.

A 3D display has been provided using an angular projection backlight. Examples of particular materials and dimensions have been given to illustrate the invention, but the invention is not limited to just these examples. Other variations and embodiments of the invention will occur to those skilled in the art.

We claim:

1. A three-dimensional (3D) display method using an angular projection backlight, the method comprising:
providing a front panel with an array of selectable color pixels;
providing a backlight panel with bi-directional edge-coupled waveguides formed in a plurality of rows, where each waveguide interfaces with a corresponding sequence of selectively enabled light extraction cells;
selecting a first waveguide row;
enabling a first light emitting diode (LED) in a first column of LEDs interfaced to a first edge of the backlight waveguides, where the first LED supplies light to the corresponding first waveguide row;
selecting a light extraction cell to enable overlying the first waveguide row;
selecting an angle tuning voltage;
supplying the selected angle tuning voltage to the enabled light extraction cell;
projecting light from the enabled light extraction cell at a first angle with respect to a backlight panel surface in response to the angle tuning voltage and an angle at which light is received from the underlying waveguide row;
subsequent to disabling the first LED, supplying light from a second LED in a second column of LEDs interfaced to a second edge of the backlight waveguides, where the second LED supplies light to the corresponding first waveguide row; and,
projecting light from the enabled light extraction cell at a second angle with respect to the backlight panel surface in response to the angle tuning voltage and an angle at which light is received from the underlying waveguide row.

2. The method of claim 1 wherein supplying light from the first LED includes supplying the light in a first sub-frame of a time division multiplexed (TDM) sequence;
wherein supplying light from the second LED includes supplying the light in a second sub-frame of the TDM sequence;
wherein projecting light at the first and second angles includes projecting light at opposite non-orthogonal first and second angles;
the method further comprising:
iteratively selecting waveguide rows, a light extraction cell to enable in each sequence, and alternately illuminating each enabled light extraction cell in the first and second sub-frames; and,
projecting a 3D representation of front panel color pixels respectively overlying enabled light extraction cells.

3. The method of claim 1 further comprising:
simultaneously supplying light to an enabled light extraction cell overlying the first waveguide row from both the first and second LEDs;
iteratively selecting waveguide rows, a light extraction cell to enable in each sequence, accepting angle tuning voltages for enabled light extraction cells, and simultaneously enabling LEDs from the first and second edges of each selected waveguide row; and,
projecting a two-dimensional (2D) representation of front panel color pixels respectively overlying enabled light extraction cells.

4. The method of claim 1 wherein selecting the angle tuning voltage includes selecting a minimum angle tuning voltage;
wherein projecting light at the first and second angles includes projecting light at first and second angles that are minimally obtuse with respect to the backlight panel surface in response to the minimum angle tuning voltage;
the method further comprising:
iteratively selecting waveguide rows, a light extraction cell to enable in each sequence, accepting minimum angle tuning voltages for each enabled light extraction cell, and alternately enabling LEDs from the first and second edges of each selected waveguide row; and,
projecting a two-dimensional (2D) representation of front panel color pixels respectively overlying enabled light extraction cells.

5. The method of claim 1 wherein projecting light at the first angle includes projecting light at an obtuse first angle formed between the direction at which the light enters a waveguide row and the direction from which the light is projected from the backlight panel; and,
wherein projecting light at the second angle includes projecting light at an obtuse second angle formed between the direction at which the light enters the waveguide row and the direction from which the light is projected from the backlight panel.

6. The method of claim 5 wherein providing the backlight includes providing a backlight panel surface with a length (L) in a first horizontal plane;
wherein projecting light at the first angle includes projecting light at the first angle (φ)=second angle (φ), as follows:
tan(180−φ)=2H/(W+L);
where H is a distance along a vertical plane between the backlight panel surface and a second horizontal plane overlying the first horizontal plane,
where the vertical plane bisects L; and,
where W is a distance along the second horizontal plane bisected by the vertical plane.

7. The method of claim 6 wherein projecting light at the first angle as tan(180−φ)=2H/(W+L) includes determining the value of H in response to selecting the first and second angles.

8. The method of claim 7 wherein determining the value of H in response to selecting the first and second angles includes determining the value of H while maintaining the value of W as a constant.

9. The method of claim 1 wherein providing selectively enabled light extraction cells includes providing light extraction cells formed from liquid crystal (LC) cells interposed between transparent electrodes.

10. The method of claim 1 further comprising:
selecting the light intensity supplied by each LED.

11. A three-dimensional (3D) display with an angular projection backlight panel, the display comprising:
a front panel including an array of selectively enabled color pixels;
a backlight formed from a plurality of bi-directional edge-coupled waveguides arranged in rows with overlying sequences of selectively enabled light extraction cells, each light extraction cell including an angle tuning port for accepting an angle tuning voltage, and each enabled light extraction cell projecting light at an angle responsive to the angle tuning voltage and an angle at which light is received from the underlying waveguide row;
a first column of light emitting diodes (LEDs) interfaced to a first edge of the waveguides, where each LED supplies light to a corresponding waveguide row;
a second column of LEDs interfaced to a second edge of the waveguides, alternately engagable with the first column of LEDs, where each LED supplies light to a corresponding waveguide row;
wherein a first enabled light extraction cell overlying a first waveguide row projects light at a first angle with respect to a backlight panel top surface in response to the angle tuning voltage, enabling a first LED in the first column of LEDs, where the first LED is associated with the first waveguide row, and an angle at which light is received from the underlying waveguide row; and,
wherein the first enabled light extraction cell projects light at a second angle with respect to the front panel top surface in response to the angle tuning voltage, enabling a second LED in the second column of LEDs, where the second LED is associated with the first waveguide row, and an angle at which light is received from the underlying waveguide row.

12. The display of claim 11 wherein the light extraction cells are formed from liquid crystal (LC) cells interposed between transparent electrodes.

13. The display of claim 11 wherein the first LED is enabled to supply light in a first sub-frame of a time division multiplexed (TDM) sequence;
wherein the second LED is enabled to supply light in a second sub-frame of the TDM sequence;
where the first enabled light extraction cell projects light at opposite non-orthogonal first and second angles; and,
wherein a 3D image is projected in response iteratively selecting waveguide rows, enabling a light extraction cell in each sequence, accepting an angle tuning voltage for the enabled light extraction cell, enabling a front panel color pixel overlying each enabled light extraction cell, and illuminating each enabled light extraction cell in the first and second sub-frames.

14. The display of claim 11 wherein the first and second LEDs are simultaneously enabled;
wherein a two-dimensional (2D) image is projected in response to iteratively selecting waveguide rows, enabling a light extraction cell in each sequence, supplying an angle tuning voltage to enabled light extraction cells, enabling a front panel color pixel overlying each enabled light extraction cell, and simultaneously illuminating each enabled light extraction cell from the first and second edges of each selected waveguide row.

15. The display of claim 11 wherein each enabled light extraction cell projects light at a minimum obtuse angle with respect to a top surface of the backlight panel;
wherein the first LED is enabled to supply light in a first sub-frame of a TDM sequence;
wherein the second LED is enabled to supply light in a second sub-frame of the TDM sequence; and,
wherein a 2D image is projected in response iteratively selecting waveguide rows, enabling a light extraction cell in each sequence, accepting the minimum tuning voltage for each enabled light extraction cell, enabling a front panel color pixel overlying each enabled light extraction cell, and illuminating each enabled light extraction cell in the first and second sub-frames.

16. The display of claim 15 wherein a first enabled light extraction cell projects light at an obtuse first angle in response to enabling the first LED, where the obtuse angle is formed between the direction at which the light enters a waveguide row and the direction from which the light is projected from the backlight panel surface; and,
wherein the first enabled light extraction cell projects light at an obtuse second angle in response to enabling the second LED, where the obtuse angle is formed between the direction at which the light enters the waveguide row and the direction from which the light is projected from the backlight panel surface.

17. The display of claim 16 wherein the backlight panel has a top surface with a length (L) in a first horizontal plane;
wherein the enabled light extraction cell projects light at the first angle (φ)=second angle (φ), as follows:
tan(180−φ)=2H/(W+L);
where H is a distance along a vertical plane between the front panel top surface and a second horizontal plane overlying the first horizontal plane,
where the vertical plane bisects L; and,
where W is a distance along the second horizontal plane bisected by the vertical plane.

18. The display of claim 17 wherein the first enabled light extraction cell projects light at modified first and second angles in response to changing the angle tuning voltage, where the value of H changes while the value of W remains constant.
